(19) United States
(12) Patent Application Publication
(10) Pub. No.: US 2015/0267902 A1
(43) Pub. Date: Sep. 24, 2015

(54) Portable lighting device

(71) Applicant: Yuyao Jinfeng Electric Appliance Co., Ltd., Yuyao (CN)

(72) Inventor: JiFeng Zhang, Yuyao (CN)

(73) Assignee: Yuyao Jinfeng Electric Appliance Co., Ltd.

(21) Appl. No.: 14/545,059

(22) Filed: Mar. 19, 2015

(30) Foreign Application Priority Data
Mar. 19, 2014 (CN) 201410102303.4

(51) Int. Cl. F21V 19/00; F21V 21/096; F21V 14/00; F21L 4/00; F21L 4/02; F21V 21/088; F21V 21/08; F21V 7/22

(52) U.S. Cl. CPC F21V 19/00; F21V 21/0832; F21V 21/0965; F21V 7/22; F21L 4/005; F21L 4/027; F21V 21/0885; F21V 14/00; F21Y 2101/02

(57) ABSTRACT

A portable lighting device includes a light housing having a housing body defining a receiving cavity, a light source supported in the receiving cavity of the housing body, and a direction adjusting arrangement which is rotatably mounted with the housing body in such a manner that a projecting direction of the light source is capable of being adjusted by means of a relative movement between the housing body and the direction adjusting arrangement.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a lighting device, and more particularly to a portable lighting device which is capable of adjusting a light projecting direction by means of the relative movement between a movable direction adjusting arrangement and a light housing thereof.

2. Description of Related Arts

A current lighting device, especially an outdoor lighting fixture such as a flashlight, generally adopts an LED array as a light source, so that it can provide a good lighting effect and a relatively long period of usage before it should be charged. It can be understood that the outdoor flashlight using the LED array as the light source also is advantageous in that it is light, portable and having a relatively small volume. Therefore, the outdoor flashlight with the LED light source is widely spread in the market and accepted by the consumers.

Such a typical lighting device with the LED light source generally includes an LED light source which is powered by a battery, a handheld housing for a user to hold on, and optionally a light collecting device such as a light reflector for collecting and directing light beams of the LED light source. Generally, the handheld housing of the current flashlight is constructed to be an integral tubular structure, so that it is convenient and comfortable for the user to hold on the handheld housing with his or her hand and take the flashlight away.

However, this type of flashlight has several drawbacks. First of all, the light beams of the LED light source of the conventional flashlight only project out through the head portion of the handheld housing, so that the illumination effect of the conventional flashlight is limited by its spot light pattern. In other words, the conventional flashlight cannot be used to provide illumination to a relatively large area. Secondly, a projecting direction of the light beams of the flashlight is in accordance with a direction along the length of the handheld housing, so that when the position of the handheld housing remains unchanged, the light beams of the LED light source will continuously reach to the same area. Therefore, the user has to user his or her hand to adjust the angle and position of the handheld housing so as to provide a desired light projecting direction, and sometime it is really difficult for the user to keep an uncomfortable holding posture for a relatively long time. Furthermore, the conventional flashlight has to be kept in the hand of the user during use. In other words, the conventional flashlight cannot be affixed to the environment when it is used for illumination, so that the hand of the user holding on the handheld housing cannot be spared for other uses.

Nowadays, more and more people prefer to take part in outdoor activities such as camping and travelling, thus an outdoor lighting device for providing illumination is an indispensable tool for such activities. However, as discussed above, the conventional flashlight is still inconvenient to use, so that it cannot fulfill the need of the user.

### SUMMARY OF THE PRESENT INVENTION

The invention is advantageous in that it provides a portable lighting device, which comprises a light housing, a direction adjusting arrangement movably coupled with the light housing, and a light source supported by the light housing, wherein the light projecting direction of the light source can be adjusted by means of the relative movement between the light housing and the direction adjusting arrangement.

Another advantage of the invention is to provide a portable lighting device, wherein the direction adjusting arrangement is capable of rotating with respect to the light housing, so that an angle between the direction adjusting arrangement and the light housing can be adjusted, and thus the light beams of light source can be directed to a desired orientation.

Another advantage of the invention is to provide a portable lighting device, wherein the direction adjusting arrangement may define a rotation cavity so that an end portion of the light housing is capable of rotating in and out of the rotation cavity, so that the projecting direction of the light beams of the light source can be selectively adjusted.

Another advantage of the invention is to provide a portable lighting device, wherein an end portion of the light housing may define the rotation cavity, so that the direction adjusting arrangement may rotate in and out of the rotation cavity, so that the projecting direction of the light beams of the light source can be selectively adjusted.

Another advantage of the invention is to provide a portable lighting device, wherein the direction adjusting arrangement may be used for affixing to the environment, enabling the portable lighting device being mounted to the environment for providing illumination, so that there is no need for holding the portable lighting device by the hands of the user, and thus the hands of the user can be set free for doing other jobs.

Another advantage of the invention is to provide a portable lighting device, which is capable of being worn on the user so as to be constructed to be a wearable lighting device, so that the lighting device is more convenient for taking out to outdoor cavities.

Another advantage of the invention is to provide a portable lighting device, wherein the light source may comprise one or more light units each provides an illumination pattern, each of the light units may comprise one or more LED illumination members, so that the LED light source is cost-effective and also provides a good illumination effect.

Another advantage of the invention is to provide a portable lighting device, wherein the light source can be constructed to provide illumination at front side and one or more lateral sides, so that the illumination area can be greatly increased.

Another advantage of the invention is to provide a portable lighting device, wherein the light units of the light source may provide different illumination patterns, such as a spot light pattern and an area light pattern, so that the user is enabled to select his or her desired light unit for providing illumination.

Another advantage of the invention is to provide a portable lighting device, wherein the light housing may rotate with respect to its central axis so as to adjust the direction of the light beams of the light source.

Another advantage of the invention is to provide a portable lighting device, wherein no complicated structure is required, and the cost is low, so that the portable lighting device is affordable for a large population of consumers.

Additional advantages and features of the invention will become apparent from the description which follows, and may be realized by means of the instrumentalities and combinations particular point out in the appended claims.

According to the present invention, the foregoing and other objects and advantages are attained by a portable lighting device comprising a light housing comprising a housing body defining a receiving cavity, a light source supported in the receiving cavity of the housing body, and a direction adjusting arrangement which is rotatably mounted with the housing body in such a manner that a projecting direction of the light source is capable of being adjusted by means of a relative movement between the housing body and the direction adjusting arrangement.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a portable lighting device according to a first preferred embodiment of the present invention.

FIG. 2 is another perspective view of the portable lighting device according to the above first preferred embodiment of the present invention.

FIG. 3 is an exploded view of the portable lighting device according to the above first preferred embodiment of the present invention.

FIG. 4 is perspective view illustrating the assembled direction adjusting arrangement of the portable lighting device according to the above first preferred embodiment of the present invention.

FIG. 5 is an exploded view illustrating the direction adjusting arrangement of the portable lighting device according to the above first preferred embodiment of the present invention.

FIG. 6 is a partially enlarged view illustrating the movable engaging structure of the direction adjusting arrangement of the portable lighting device according to the above first preferred embodiment of the present invention.

FIG. 7 is a sectional view along ling B-B of FIG. 6 for illustrating the movable engaging structure of the direction adjusting arrangement of the portable lighting device according to the above first preferred embodiment of the present invention.

FIG. 8 is a perspective view illustrating the portable lighting device being in use according to the above first preferred embodiment of the present invention.

FIG. 9 is another perspective view illustrating the portable lighting device being in use according to the above first preferred embodiment of the present invention.

FIG. 10 is another perspective view illustrating the portable lighting device being in use according to the above first preferred embodiment of the present invention.

FIG. 11 is a perspective view illustrating the hanging hook of the portable lighting device being according to the above first preferred embodiment of the present invention.

FIG. 12 is a perspective view of a portable lighting device according to a second preferred embodiment of the present invention.

FIG. 13 is another perspective view of the portable lighting device according to the above second preferred embodiment of the present invention.

FIG. 14 is an exploded view of the portable lighting device according to the above second preferred embodiment of the present invention.

FIG. 15 is a perspective view illustrating the light housing and the direction adjusting arrangement of the portable lighting device according to the above second preferred embodiment of the present invention.

FIG. 16 is an exploded view of the direction adjusting arrangement of the portable lighting device according to the above second preferred embodiment of the present invention.

FIG. 17 is a perspective view illustrating the assembled movable engaging structure of the direction adjusting arrangement of the portable lighting device according to the above second preferred embodiment of the present invention.

FIG. 18 is a perspective view illustrating the adjusting mechanism of the direction adjusting arrangement of the portable lighting device according to the above second preferred embodiment of the present invention.

FIG. 19 is a side perspective view illustrating the adjusting unit of the direction adjusting arrangement of the portable lighting device being pressed according to the above second preferred embodiment of the present invention.

FIG. 20 is a rear perspective view illustrating the adjusting unit of the direction adjusting arrangement of the portable lighting device being pressed according to the above second preferred embodiment of the present invention.

FIG. 21 is a schematic view illustrating the rotatable engagement between the light housing and the direction adjusting arrangement of the portable lighting device according to the above second preferred embodiment of the present invention.

FIG. 22 is a sectional view along line C-C of FIG. 21.

FIGS. 23A and 23B are respectively exploded view of the light source and light housing of the portable lighting device according to the above second preferred embodiment of the present invention.

FIG. 24 is a perspective view illustrating the portable lighting device being in use according to the above second preferred embodiment of the present invention.

FIG. 25 is another perspective view illustrating the light housing of the portable lighting device being rotated for use according to the above second preferred embodiment of the present invention.

FIG. 26 is another perspective view illustrating the portable lighting device being in use according to the above second preferred embodiment of the present invention.

FIG. 27 is another perspective view illustrating the portable lighting device being in use according to the above second preferred embodiment of the present invention

FIG. 28 is a perspective view illustrating the hanging hook used for hanging the portable lighting device according to the above second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

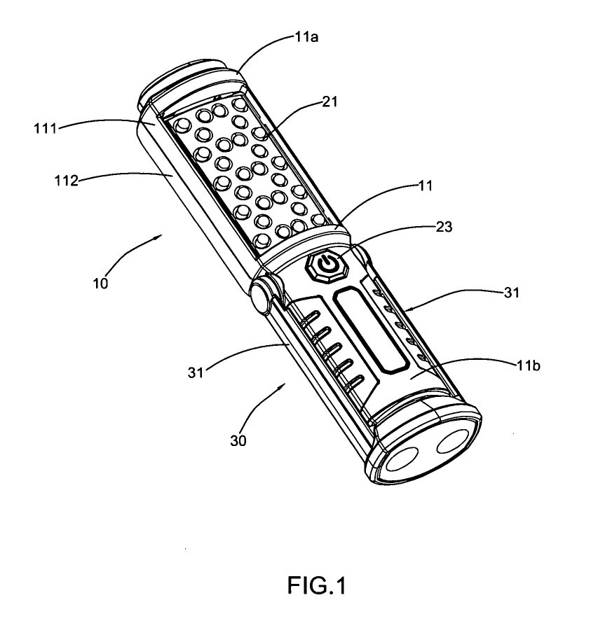

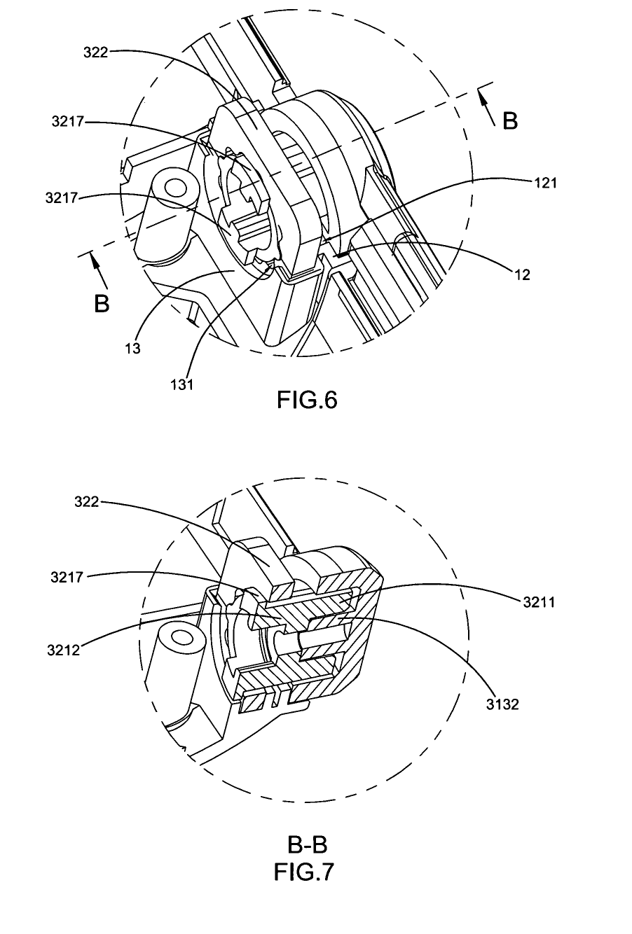

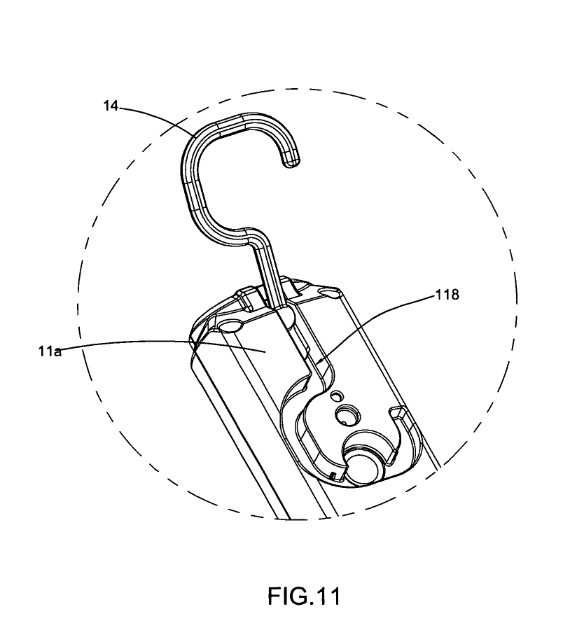

Referring to FIGS. 1 to 11 of the drawings, a portable lighting device according to a first preferred embodiment of the present invention is illustrated. As shown in the drawings, the portable lighting device comprises a light housing 10, a light source 20, and a direction adjusting arrangement 30. The light source 20 is supported by the light housing 10 and the light beams of the light source 20 project out from the light housing 10 for providing illumination. The direction adjusting arrangement 30 is movably coupled with the light housing 10 in such a manner that a direction of the light beams of the light source 20 can be adjusted by means of a relative movement between the light housing 10 and the direction adjusting arrangement 30.

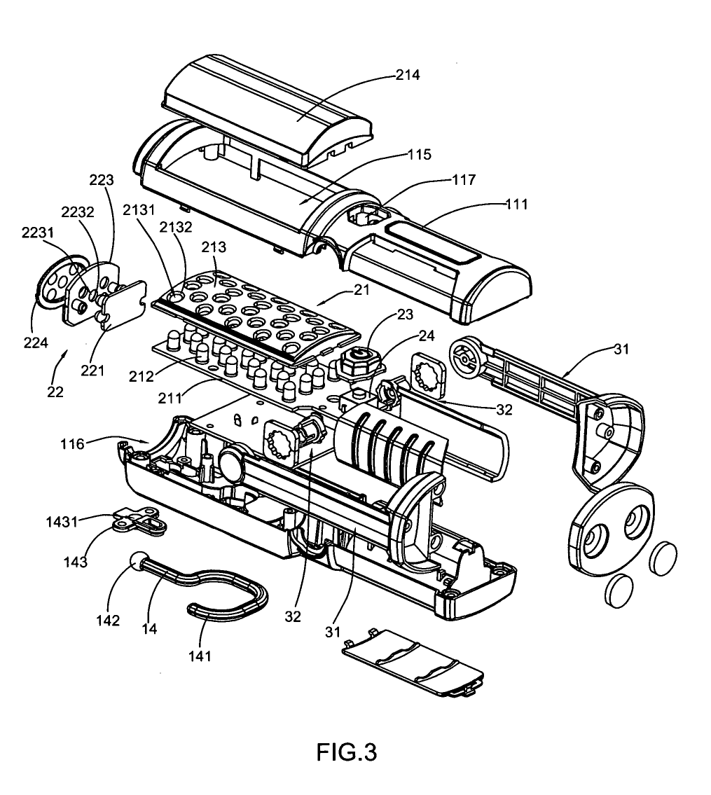

More specifically, the light housing 10 is preferred to be constructed to be cylindrical shaped, the light source 20 is supported within the light housing 10. Referring to FIG. 3 of the drawings, according to this preferred embodiment, the light housing 10 comprises a housing body 11 which comprises a first housing 111 and a second housing 112. The first and second housings 111 and 112, which can be respectively embodied as an upper housing and a lower housing in this preferred embodiment, are mounted with each other to define a receiving cavity 113 therebetween. Accordingly, the light source 20 is received in the receiving cavity 113 and supported within the first and second housings 111 and 112. It is appreciated that the cylindrical shape and the upper and lower configuration of the light housing 10 of this preferred embodiment is exemplary only and do not limit the scope of the present invention.

The direction adjusting arrangement 30 is movably mounted to the housing body 11 in such a manner that the direction adjusting arrangement 30 is capable of being rotated with respect to the housing body 11. In other words, the position and extending direction of the housing body 11 can be adjusted by rotating the housing body with respect to the direction adjusting arrangement 30, so that the light beams projecting out of the light housing 10 can be selectively directed to desired locations.

Referring to FIGS. 3 and 9 of the drawings, according to this preferred embodiment, the direction adjusting arrangement 30 comprises at least one support unit 31, and at least one rotation unit 32. As shown in the drawings, the support unit 31 is pivotally coupled to the corresponding rotation unit 32. Accordingly, the direction adjusting arrangement 30 further defines a rotation cavity 33, at least one portion of the housing body 11 is capable of being rotated in and out of the rotation cavity 33, so that the extending direction of the housing body can be adjusted.

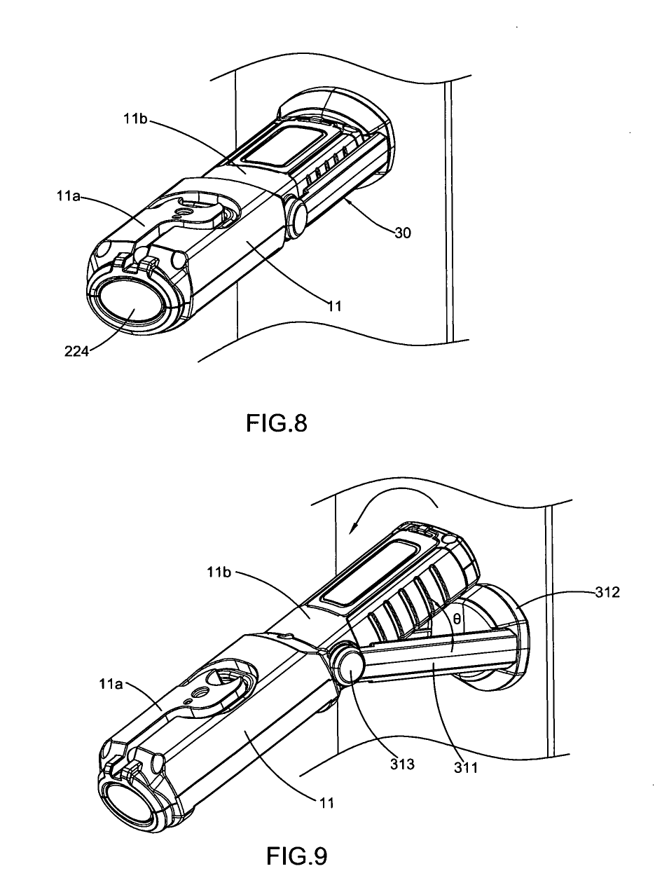

More specifically, the first and second housings 111 and 112 of the housing body 11 are mounted with each other to define a front portion 11a and a rear portion 11b integrally extended from the front portion 11a along a length of the housing body 11. It should be noticed that the definition of the front and rear portions 11a and 11b should not be limiting. That is to say, in a practical use, the front portion 11a also may be presented at a rear side while the rear portion 11b may be presented at a front side. Referring to FIGS. 8 and 9 of the drawings, according to this preferred embodiment, the rear portion 11b is capable of being rotated in and out of the rotation cavity 33 so as to adjust the relative position between the support unit 31 and the housing body 11. In other words, when the rear portion 11b is received in the rotation cavity 33, the support unit 31 is extended along the length of the housing body 11 so as to form an integral cylindrical structure. When the rear portion 11b is rotated out of the rotation cavity 33, an angle θ is actually defined between the support unit 31 of the direction adjusting arrangement 30 and the housing body 11. It is thus can be seen that the value of the angle θ can be adjusted by the relative movement between the support unit 31 of the direction adjusting arrangement 30 and the housing body 11, so that the position of the light source 20 which is supported in the housing body 11 can be adjusted, and thus the light beams of the light source 20 can be directed to desired locations.

According to this preferred embodiment, the rear portion 11b of the housing body 11 can be rotated both in clockwise and counterclockwise directions. In other words, the rotation cavity 33 of the direction adjusting arrangement 30 of this preferred embodiment may communicate with the outer side both at the top and bottom sides, and thus the angle θ between the support unit 31 of the direction adjusting arrangement 30 and the housing body 11 may be ranged from 0-360°. The person of ordinary skill in the art shall understand that the value range of the angle θ is exemplary only and is not interpreted to limit the present invention. In some examples, when the rear portion 11b of the housing body 11 is to be rotated out of the rotation cavity 33, the rear portion 11b of the housing body 11 may only be rotated in clockwise direction and return back in counterclockwise direction. In some examples, the rear portion 11b of the housing body 11 may be rotated only in counterclockwise wise direction to get out of the rotation cavity 33 and return back in clockwise direction. In other words, the rotation cavity 33 may only have one opening communicating with the outer side. In addition, the suitable range of the angle θ between the support unit 31 of the direction adjusting arrangement 30 and the housing body 11 may be selected according to design choices.

Actually, a user may use his or her hand to hold onto the direction adjusting arrangement 30 of the portable lighting device, and then he or she may use the other hand or other free fingers of the same hand to press or pull the housing body 11 so as to adjust the position of the housing body 11. More specifically, as an example, when the rear portion 11b of the housing body 11 is pressed or pulled downward, or the front portion 11a of the housing body 11 is pulled or pressed upward, the housing body 11 will rotate in clockwise direction, and when the rear portion 11b of the housing body 11 is pressed or pulled upward, or the front portion 11a of the housing body 11 is pulled or pressed downward, the housing body 11 will rotate in counterclockwise direction, so that the housing body 11 rotates with respect to the direction adjusting arrangement 30.

The direction adjusting arrangement 30 of this preferred embodiment comprises two support units 31 and two rotation units 32 connected to the two support unit 31 respectively. In other words, the direction adjusting arrangement 30 comprises two adjusting units each comprising a support unit 31 and a rotation unit 32. Accordingly, the rotation cavity 33 is defined between the two support units 31. More specifically, each of the support units 31 comprises an elongated support leg 311 defining a proximate end 3111 and a distal end 3112, a support base 312 extend from the proximate end 3111 of the support panel 311, and a pivot member 313 extend from the distal end 3112 of the support leg 311. Preferably, each of the support units 31 is a one-piece structure. In other words, the support base 312 and the pivot member 312 are respectively integrally and vertically extended from two opposite ends of the support let 311.

According to this preferred embodiment, the two adjusting units each including the support unit 31 and the rotation unit 32 are symmetrical with respect to the housing body 11. More specifically, when the rear portion 11b of the housing body 11 is received in the rotation cavity 33, the rear portion 11b of the housing body 11 is actually sandwiched between the two support legs 311 which can be embodied as two elongated panels while the rear end thereof is covered by the two support bases 312.

Preferably, an outer diameter of the rear portion 11b of the housing body 11 is smaller than an outer diameter of the front portion 11a of the housing body 11, and the two support units 31 are provided around the rear portion 11b of the housing body 11 in such a manner that an outer surface along the length of the support leg 311 can extend along a same plane with the an outer surface along the length of the front portion 11a of the housing body 11. In other words, the direction adjusting arrangement 30 of this preferred embodiment can be installed with the housing body 11 to from an integral cylindrical structure, so that the aesthetic appearance of the entire portable lighting device of this preferred embodiment can be enhanced.

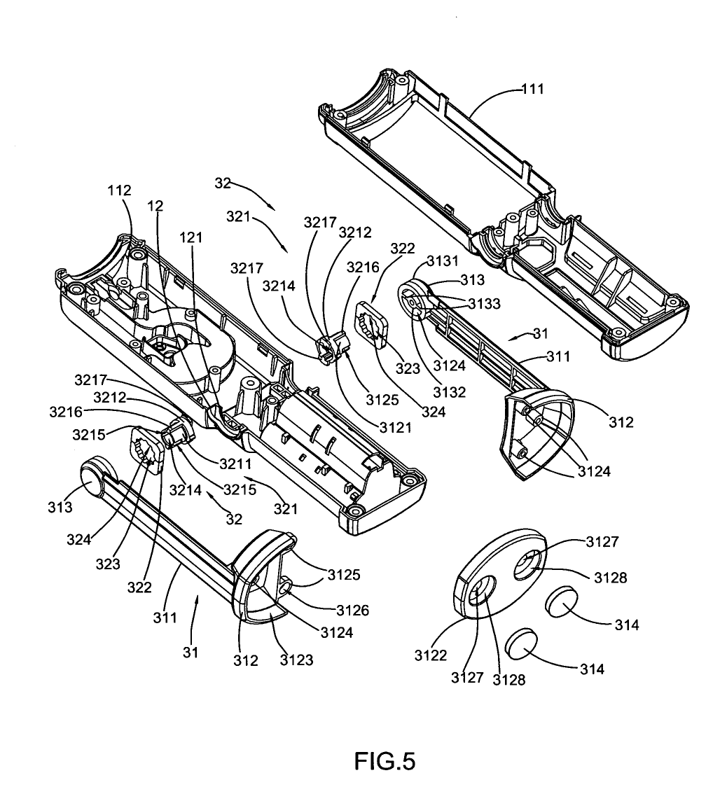

Accordingly, the two support legs 311 are parallelly and spacedly extended to couple with the two support bases 312 to define the rotation cavity 33. Actually, the two support unit 31 can be configured to be a U-shaped frame which allows the rear portion 11b of the housing body 11 to rotate in and out of the rotation cavity 33. The two support bases 312 may be mounted with each other or may be integrated with each other to form a one-piece structure. According to this preferred embodiment, referring to FIGS. 3 and 5 of the drawings, the two support bases 312 are shown to be mounted with each other. More specifically, the two support bases 312 are constructed to form two inner base bodies 3121, and an integral outer cap 3122. The two inner base bodies 3121 are installed with each other and are mounted with the outer cap 3122 to define an inner cavity 3123.

The two inner base bodies 3121 can be mounted with each other in any suitable manners. For instance, as shown in the drawings, one of the inner base bodies 3121 is provided with two mounting columns 3124 protruded from the inner wall thereof and are extending into the inner cavity 3123, the other inner base body 3121 is provided with two corresponding mounting protrusions 3125 defining two mounting holes 3126 respectively. Each of the mounting columns 3124 penetrates through the mounting hole 3126 of the mounting protrusion 3125 so that the two inner base bodies 3121 are locked with each other. Preferably, each of the mounting columns 3124 is a screw while the mounting protrusion 3125 is a nut, and the mounting column 3124 is screwed into the nut to firmly mount the two inner base bodies 3121 in position.

The two inner base bodies 3121 can be mounted with the outer cap 3122 in a similar manner. More specifically, each of the inner base bodies 3121 is further provided with a mounting column 3124 protruded from the inner wall thereof to engage with a mounting hole 3127 of the outer cap 3122. It is worth mentioning that the above mentioned engagement between the two inner base bodies 3121, and the engagement between the two inner base bodies 3121 and the outer cap 3122 are exemplary only.

In addition, the outer cap 3122 further has one or more mounting grooves 3128, while the direction adjusting arrangement 30 further comprises one or more magnetic mounting members 314 which are installed in the corresponding mounting grooves 3128. As shown in FIG. 3 of the drawings, as an example, two magnetic mounting members 314 are respectively provided in two mounting grooves 3128 in the outer cap 3122. Accordingly, each of the magnetic mounting members 314 has magnetic attracting ability, and thus the magnetic mounting members 314 enable the direction adjusting arrangement 30 being mounted on a magnetic metal surface. In other words, when the environment surface is made of magnetic metal, such as a surface of a vehicle, the two magnetic mounting members 314 are detachably mounted on the environment surface and the two magnetic mounting members 314 provide a magnetic attracting force between the two magnetic mounting members 314 and the environment surface which is strong enough for preventing the portable lighting device from slipping off from the environment surface.

Referring to FIGS. 8 and 9 of the drawings, the portable lighting device can be mounted to the environment surface via magnetic attracting manner between the two magnetic mounting members 314 and the environment surface. Therefore, there is no need for the user to use his or her hand to hold on the portable lighting device, and thus the two hands of the user can be free for doing other jobs. In addition, when the housing body 11 of the portable lighting device is rotated with respect to the direction adjusting arrangement 30, the angle θ between the support legs 311 of the support units 31 of the direction adjusting arrangement 30 and the housing body 11 can be adjusted, so that the light projecting direction of the light source 20 can be adjusted.

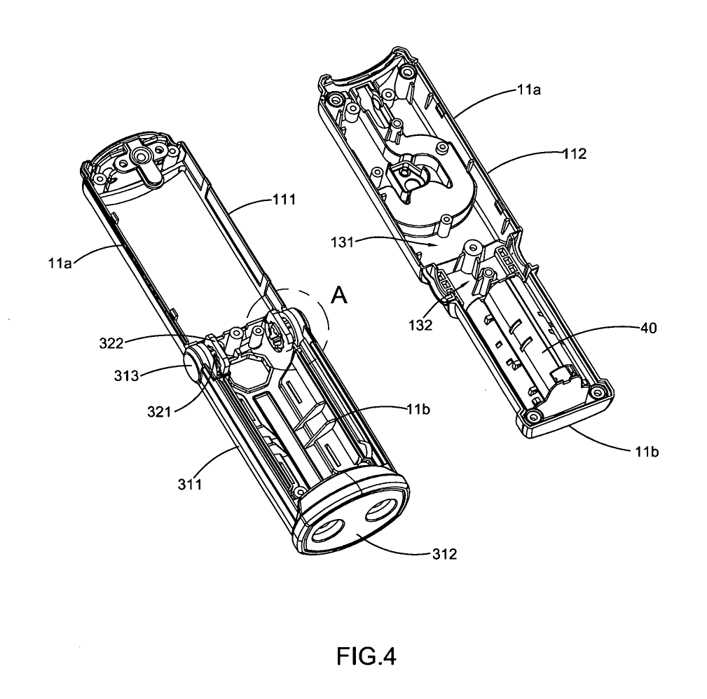

According to this preferred embodiment, each of the support leg 311 is capable of rotating with respect to the corresponding pivot member 313 which functions as a pivot point. Each of the pivot members 313 is coupled with the corresponding rotation unit 32 for enabling the rotation movement. More specifically, referring to FIGS. 4-7 of the drawings, each of the two rotation unit 32, e.g. left and right rotation units 32 shown in the drawings, which can be received in the receiving cavity 113 of the housing body 11, comprises a rotating member 321, and a retaining member 322 defining a rotation channel 323. Accordingly, the rotating member 321 and the retaining member 322 of each rotation unit 32 of the direction adjusting arrangement 30 extend into the receiving cavity 113 of the housing body 11, so that the rotation unit 32 is hidden within the housing body 11, while each of the support units 32 is provided at an outer side of the housing body 11.

The rotating member 321 is rotatably mounted in the corresponding rotation channel 323 of the retaining member 322, the pivot member 313 is mounted with the rotating member 321, so that when the rotating member 321 is rotating in the rotation channel 323 of the retaining member 322, the corresponding support leg 311 is driven by the pivot member 313 to rotate. Accordingly, when the support leg 311 is driven to rotate with respect to the pivot member 313, the pivot member 313 will drive the rotating member 321 to rotate in the rotation channel 323 of the retaining member 322.

In addition, the retaining member 322 further has a plurality of retaining grooves 324 indented along an inner circumferential surface thereof. The distance between two adjacent retaining grooves 324 may be the same or different. The rotating member 321 comprises a connecting portion 3211 and a rotating portion 3212 integrally extended from the connecting portion 3211. The rotation member 321 further comprises one or more retaining protrusion 3213, e.g. two retaining protrusion 3213, protruded from an outer circumferential surface of the rotating portion 3212. Accordingly, each retaining protrusion 3213 is shaped and sized to couple with the retaining groove 324 of the retaining member 322. Therefore, when the rotating member 321 stops rotating in the rotation channel 323 of the retaining member 322, the retaining protrusion 3213 of the rotation member 321 is received in one of the retaining grooves 324 of the retaining member 322 so as to block further self-rotation of the rotating member 321. In other words, the engagement between the retaining protrusion 3213 of the rotation member 321 and the retaining groove 324 of the retaining member 322 will retain the rotation unit 32 in position so that the angle θ between the support legs 311 of the support units 31 of the direction adjusting arrangement 30 and the housing body 11 can be kept unchanged when there is no auxiliary external force applied to the rotation unit 32 via the pivot member 313 of the support unit 31.

As shown in FIG. 5 of the drawings, according to this preferred embodiment, the connecting portion 3211 of the rotating member 321 is constructed to have a tubular structure defining an elongated connecting channel 3214 with one or more slots 3215, e.g. two symmetrical slots 3215, communicating the connecting channel 3214 to the outer side. Accordingly, the pivot member 313 comprises a cap body 3131, a central shaft 3132 extended from an inner surface of the cap body 3131 within the cap body 3131, and one or more driving panels 3133 extended from the central shaft 3132, e.g. two symmetrical driving panels 3133 provided at two opposite sides of the central shaft 3132 and are received in the ring cavity 3134 formed between the cap body 3131 and the central shaft 3132. When the pivot member 313 of each support unit 31 is assembled with the corresponding rotation unit 32, the central shaft 3132 of the pivot member 313 is retained in the connecting channel 3214 of the connecting portion 3211 of the rotating member 321 of the rotation unit 32, the two driving panels 3133 of the pivot member 313 are respectively fitted into the two slots 3215 of the connecting portion 3211 of the rotating member 321 of the rotation unit 32. Therefore, the connecting portion 3211 of the rotating member 321 is firmly secured to the corresponding pivot member 313 of the support unit 31. Accordingly, when the pivot member 313 is rotated, the cap body 3131 of the pivot member 313 will be rotated to drive the two driving panels 3133 to rotate, and then the two driving panels 3133 in the two slots 3125 will drive the connecting portion 3211 of the rotating member 321 to rotate, so that the rotating portion 3212 of the rotating member 321 will rotate in the rotation channel 323 of the retaining member 322, and when the user stops the rotation, the retaining protrusion 3213 will be remained in the corresponding retaining groove 324 of the retaining member 322 to block the further movement of the rotating portion 3212 of the rotating member 321. Therefore, the angle θ between the support legs 311 of the support units 31 of the direction adjusting arrangement 30 and the housing body 11 is actually determined by the position of the retaining protrusion 3213 which is retained in the corresponding retaining groove 324 of the retaining member 322.

Each rotating member 321 may further comprise one or more retaining arms 3216 extended from the connecting portion 3211 thereof, e.g. two retaining arms 3216 integrally formed at two opposite sides of the connecting portion 3211 thereof. Therefore, when the connecting portion 3211 of the rotating member 321 is engaged with the corresponding pivot member 313 of the support unit 31, the two retaining arms 3216 are retained between the cap body 3131 and the central shaft 3132 of the pivot member 313 so as to enhance the frictional contact between the pivot member 313 and the rotating member 321.

Furthermore, each rotating member 321 may further comprise one or more retaining ribs 3217 radially extended from an outer side of the rotating portion 3212 thereof for biasing the outer wall of the retaining member 322, e.g. two retaining ribs 3217 are radially protruded from the rotating portion 3212 thereof. Accordingly, the two retaining ribs 3217 are not received in the rotation channel 323 of the retaining member 322, but is provided at an outer side of the rotation channel 323 of the retaining member 322, so that the movement along the length of the rotating member 321 is prevented, the retaining member 322 is also restricted between the two retaining ribs 3217 of the rotating member 321 and the cap body 3131 of the pivot member 313.

Referring to FIG. 5 of the drawings, the light housing 10 comprises a seat portion 12 defining a circular groove 121 at each of the two lateral sides of the housing body 11 at the connection between the front portion 11a and the rear portion 11b of the housing body 11. More specifically, the seat portion 12 is integrated with the first and second housing 111 and 112 to form the circular groove 121. The cap body 3131 of each of the two pivot members 313 is seated in the circular groove 121 and is supported by the seat portion 12. Accordingly, the cap body 3131 is shaped and sized to couple with the corresponding the circular groove 121 in the seat portion 12, and the cap body 3131 is rotatably mounted in the circular groove 121.

In addition, the light housing 13 further comprises a retention portion 13 defining a retention groove 131 for retaining each retaining member 322 in position. According to this preferred embodiment, the retention portion 13 is integrally formed with the seat portion 12, and both of the retention portion 13 and the seat portion 12 can be integrated with the housing body 11.

The housing body 11 may be constructed to be any structure for receiving the light source 20. According to this preferred embodiment, the first and second housing 111 and 112 are respectively embodied as upper and lower housings which are mounted together to form the receiving cavity 113 by any suitable mounting manners such as tongue-groove engaging manner, and screw-nut engaging manner. Referring to FIGS. 3 and 4 of the drawings, the receiving cavity 113 is further divided into a light source cavity 1131 and a power source cavity 1132 in this preferred embodiment. More specifically, the first and second housing 111 and 112 are assembled with each other in such a manner that the front portion 11a of the housing body 11 defines the light source cavity 1131 while the rear portion 11b of the housing body 11 defines the power source cavity 1131. Accordingly, the light source cavity 1132 is arranged for receiving the light source 20, while the power source cavity 1131 is arranged for receiving the power supply of the light source 20.

Correspondingly, the portable lighting device is assembled with a power source 40 when in use. The power source 40 can be embodied as one or more batteries which can be rechargeable batteries, dry cells, or other suitable power supply arrangements. Accordingly, the power source 40 can be electrically connected to the light source 20, so that the light source 20 is powered by the power source 40 for providing illumination. Referring to FIG. 3 of the drawings, the housing body 11 further comprises a power source lid 114, when the power source lid 114 is removed, the power source cavity 1131 is exposed so that the user can remove the used batteries or replace new batteries in the power source cavity 1131.

According to this preferred embodiment, as shown in FIG. 3 of the drawings, the light source 20 comprises a first lighting unit 21 and a second lighting unit 22 which are adapted for electrically connecting to the power source 40 for providing illumination. More specifically, the first lighting unit 21 comprises a first circuit board 211 which is electrically connected to the power source 40, and one or more first lighting members 212 mounted on the first circuit board 211. As an option, the first lighting unit 21 further comprises one or more first light reflecting members 213, and a first light distributing lid 214. Accordingly, areas of the first light distributing lid 214 corresponding to the first lighting members 212 or the entire first light distributing lid 214 are made of transparent material. The housing body 11 of the light housing 10 has a first light opening 115 for mounting the first light distributing lid 214 in position. Therefore, the first lighting members 212 are powered by the power source 40 to produce first light beams, and then the first light beams project out through the light distributing lid 214 to provide a first lighting pattern.

According to this preferred embodiment, the first lighting unit 21 comprises an integral first light reflecting member 213 which has a plurality of first light reflecting channel 2131 penetrating a thickness of the first light reflecting member 213. Each of the first light reflecting channel 2131 is formed with a light reflecting wall 2132 which can be cone-shaped. Therefore, each of the first lighting members 212 can be received in the corresponding first light reflecting channel 2131, and the first light beams reaching to the light reflecting wall 2132 are reflected, so that the first light beams are collected and gathered to project out through the first light distributing lid 214 so as to enhance the light efficiency. Alternatively, the first light reflecting member 213 may only have a single light reflecting channel 2131 for receiving the plurality of first lighting members 212, and a single light reflecting wall 2132 for reflecting and collecting the first light beams of the plurality of first lighting members 212.

Similarly, the second lighting unit 22 comprises a second circuit board 221 which is electrically connected to the power source 40, and one or more second lighting members 222 mounted on the second circuit board 221. As an option, the second lighting unit 22 further comprises one or more second light reflecting members 223, and a second light distributing lid 224. Accordingly, areas of the second light distributing lid 224 corresponding to the second lighting members 222 or the entire second light distributing lid 224 are made of transparent material. The housing body 11 of the light housing 10 has a second light opening 116 for mounting the second light distributing lid 224 in position. Therefore, the second lighting members 222 are powered by the power source 40 to produce second light beams, and then the second light beams project out through the light distributing lid 224 to provide a second lighting pattern.

According to this preferred embodiment, the second lighting unit 22 comprises an integral second light reflecting member 223 which has a plurality of second light reflecting channel 2231 penetrating a thickness of the second light reflecting member 223. Each of the second light reflecting channel 2231 is formed with a light reflecting wall 2232 which can be cone-shaped. Therefore, each of the second lighting members 222 can be received in the corresponding second light reflecting channel 2231, and the second light beams reaching to the light reflecting wall 2232 are reflected, so that the second light beams are collected and gathered to project out through the second light distributing lid 224 so as to enhance the light efficiency. Alternatively, the second light reflecting member 223 may only have a single light reflecting channel 2231 for receiving the plurality of second lighting members 222, and a single light reflecting wall 2232 for reflecting and collecting the second light beams of the plurality of second lighting members 222.

More specifically, the first lighting unit 21 is arranged for providing the first lighting pattern at a lateral side of the housing body 11 of the light housing 10, while the second lighting unit 22 is arranged for providing the second lighting pattern at an end side of the housing body 11 of the light housing 10. As shown in the drawings, as an example, the first lighting unit 21 projects out the first light beams from the first light opening 115 at a top side of the housing body 11, while the second lighting unit 22 projects out the second light beams from the second light opening 116 at a front side of the housing body 11. In other words, the first light opening 115 can be embodied as a top light opening 115 which is formed in the first housing 111, and the first light distributing lid 214 is assembled at the first housing 111 allowing the first light beams to pass therethrough. The second light opening 116 can be embodied as a front light opening 116 which is formed by the first and second housings 111 and 112, and the second light distributing lid 224 is assembled to the front connection of first and second housings 111 and 112 allowing the second light beams to pass therethrough.

Accordingly, the light projecting direction of the first lighting unit 21 is along the length of the housing body 11 while the light projection direction of the second lighting unit 22 is along a width of the housing body 11. Therefore, the first and second lighting units 21 and 22 can provide two different light beams along two different directions, so that the portable lighting device of this preferred embodiment of the present invention can provide illumination to a relatively large area, and thus the lighting efficiency of the portable lighting device is enhanced.

Preferably, the first and second lighting members 212 and 222 are all LED lighting members, so that the light source 20 is embodied as an LED light source, so that the portable lighting device can be used for illumination for a relatively long period of time during an outdoor activity, and the LED light source is also cost-effective. Alternatively, the light source 20 also may be embodied other suitable lighting arrangement which can provide light illumination.

It is worth mentioning that the plurality of first lighting members 212 may be configured to form a substantial square LED array for providing an area lighting pattern. The plurality of second lighting members 222 may be configured to form a substantial circular LED array for providing a circular spot lighting pattern. As shown in the drawings, the numbers of the first lighting members 212 may be larger than the numbers of the second lighting members 222.

Furthermore, the housing body 11 of the light housing 10 further defines a control opening 117 in a middle portion thereof for mounting a control button 23 of the light source 20. Accordingly, the control button 23 is operatively coupled to the first and second circuit boards 211 and 221 via a control circuit 24, so that when the user presses the control button 23, the user is able to select a working mode selecting from the group consisting of turning on one of the first and second lighting units 21 and 22, turning on both of the first and second lighting units 21 and 22, and turning off the light source 20.

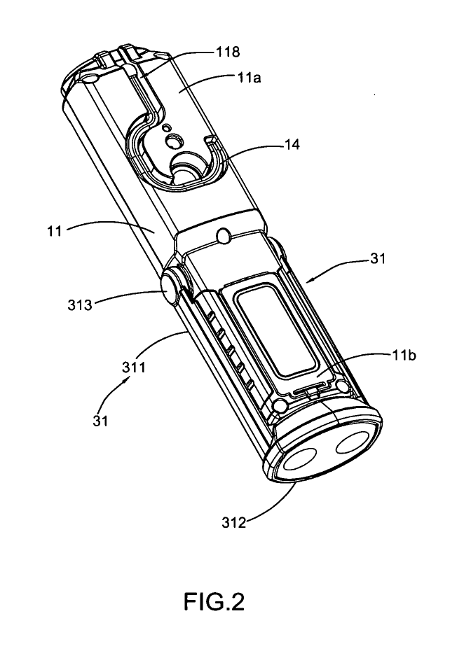

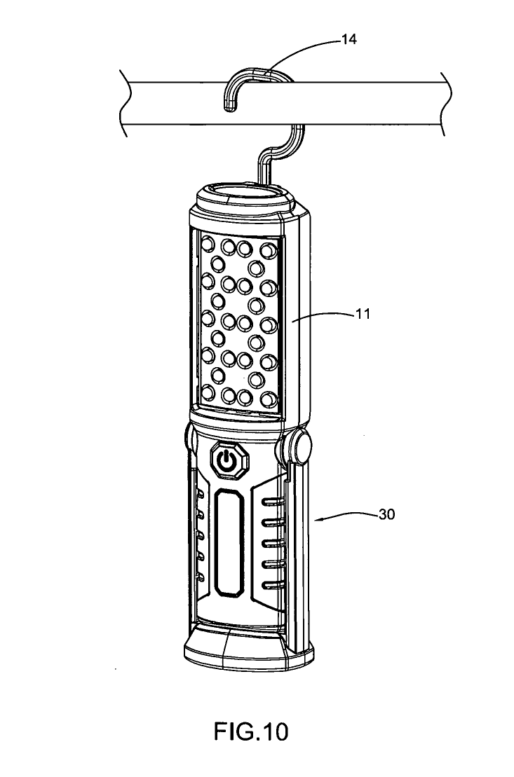

Referring to FIGS. 2 and 10-11 of the drawings, the housing body 11 of the light housing 10 further has a hook groove 118 at a bottom side thereof. Accordingly, the hook groove 118 may be formed in the second housing 112 at the front portion 11a of the housing body at a side opposite to the first light distributing lid 214. The portable lighting device further comprises a hook 14 which is rotatably mounted to the housing body 11 and is capable of being stored in the hook groove 118 of the housing body 11. Accordingly, when not in use, the hook 14 is received in the corresponding hook groove 118 of the housing body 11, when in use, as shown in FIG. 10 of the drawings, the hook 14 is pull out from the hook groove 118 of the housing body 11 for hanging on an object so as to detachably mount the portable lighting device to the object.

More specifically, the hook 14 comprises a hook body 141, a pivot ball 142 integrally extended from the hook body 141, and a hook seat 143 defining a pivot groove 1431. The hook seat 143 is supported in the housing body 11 at a front portion 11a thereof, and the pivot ball 142 is rotatably mounted in the pivot groove 1431 of the hook seat 143, so that the hook body 141 is capable of being rotated with respect to the pivot ball 142.

In other words, the portable lighting device is provided with a mounting mechanism for detachably mounting the portable lighting device to the environment when in application. Accordingly, the mounting mechanism may be embodied as the hook 14 and the magnetic mounting members 314. Alternatively, other suitable detachably mounting structure also can be introduced into the present invention. In addition, the positions of the hook 14 and the magnetic mounting members 314 can be designed according to different practical choices.

It is thus can be seen that the present invention provides a method of manufacturing a portable lighting device according to this preferred embodiment, the method comprises the following steps.

Prepare the light source 20 for providing illumination. According to this preferred embodiment, the light source 20 comprises the first lighting unit 21 and the second lighting unit 22. And thus, the step of preparing the first lighting unit 21 further comprises the step of mounting one or more first lighting members 212 on the first circuit board 211, embedding the first lighting members 212 into first light reflecting channels 2131 of the first light reflecting member 213 in such a manner that the first light reflecting member 213 is supported by the first circuit board 211 and the first light beams reaching to the first lighting reflecting wall 2132 around the first light reflecting channels 2131 can be reflected so as to condensing the first light beams; the step of preparing the second lighting unit 22 further comprises the step of mounting one or more second lighting members 222 on the second circuit board 221, embedding the second lighting members 222 into second light reflecting channels 2231 of the second light reflecting member 223 in such a manner that the second light reflecting member 223 is supported by the second circuit board 221 and the second light beams reaching to the second lighting reflecting wall 2232 around the second light reflecting channels 2231 can be reflected so as to condensing the second light beams.

Support the light source 20 in the housing body 11 of the light housing 10. More specifically, the first lighting unit 21 and the second lighting unit 22 are assembled on a second housing 112. The step may further comprise the step of mounting the first lighting unit 21 along a width of the housing body 11 while mounting the second lighting unit 22 along a length of the housing body 11. And at the last step of the method, the first housing 111 is assembled with the second housing 112 so that the first lighting unit 21 and the second lighting unit 22 are received in the receiving cavity 113 defined by the first and second housing 111 and 112.

Mount the direction adjusting arrangement 30 to the housing body 11 of the light housing 10. The step is carried out before the first and second housing 111 and 112 are assembled together. Accordingly, the two rotation units 32 are mounted on one of the first and second housing 111 and 112, the two support units 31 are respectively mounted to the two rotation units 32 by inserting the central shaft 3131 of the pivot member 313 into the connecting portion 3211 of the rotating member 321 which passes through the rotation channel 323 of the retaining member 322. Accordingly, a rotation cavity 33 is thus formed by the direction adjusting arrangement 30, so that the rear portion 11b of the housing body 11 is capable of being rotated in and out of the rotation cavity 33.

During application, the user may use his or hand to hold on the support legs 311 or support bases 312, and then rotate the housing body 11 so as to adjust the direction of the light beams of the first and second lighting units 21 and 22. Accordingly, the user only needs to simply hold the direction adjusting arrangement 30 in a normal vertical holding posture, so that there is no need for the user to keep a uncomfortable posture by inclinedly holding on the housing body 11 of the light housing 10 for directing light beams to desired locations.

Referring to FIGS. 8-10 of the drawings, when in use, the portable lighting device of the present invention can be mounted to the environment for providing illumination. Accordingly, by rotating the housing body 11 of the light housing 10 with respect to the support legs 311 of the direction adjusting arrangement 30, the light beams of the first and second lighting units 21 and 22 can be directed to desired locations.

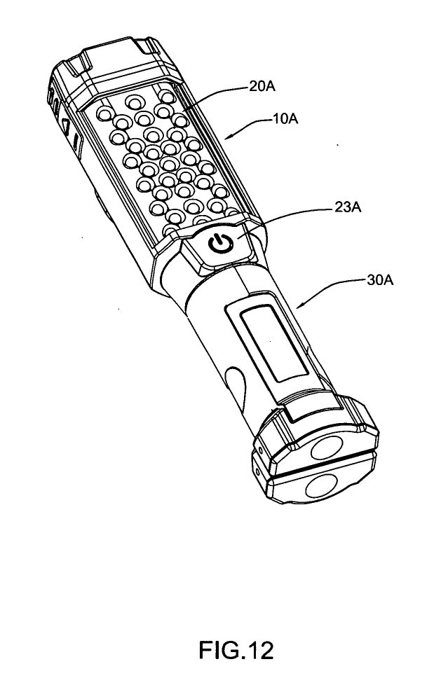

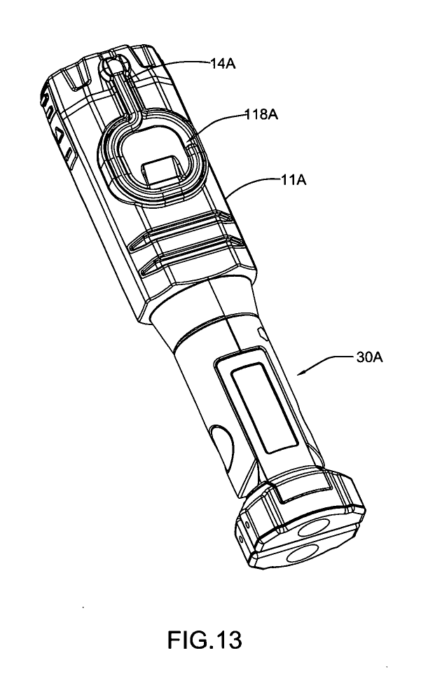

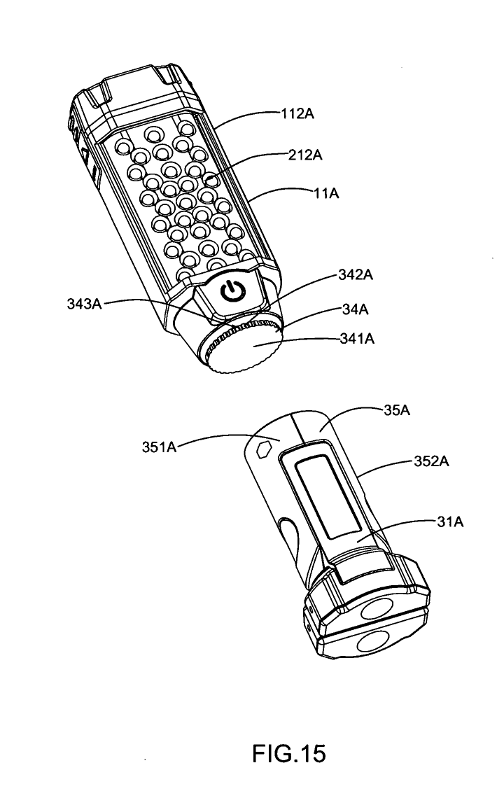

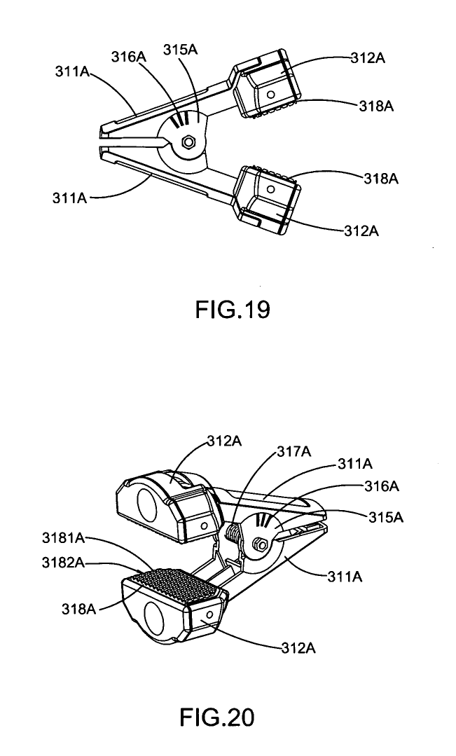

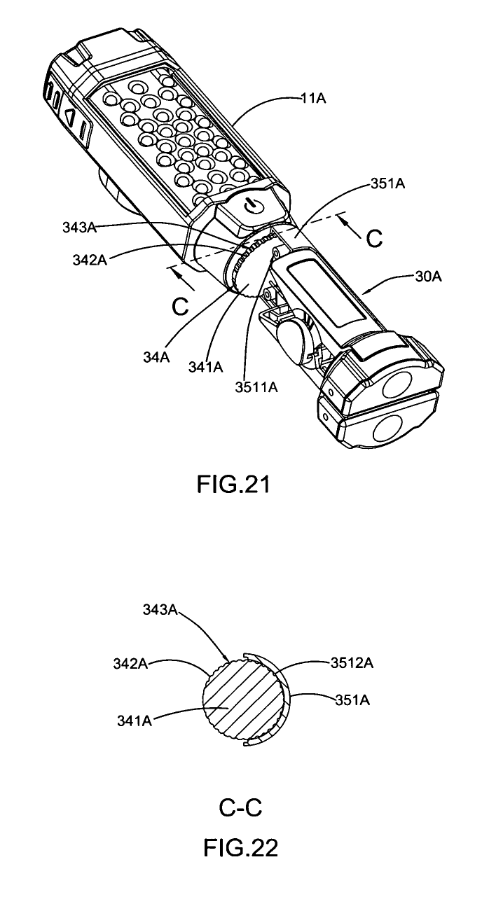

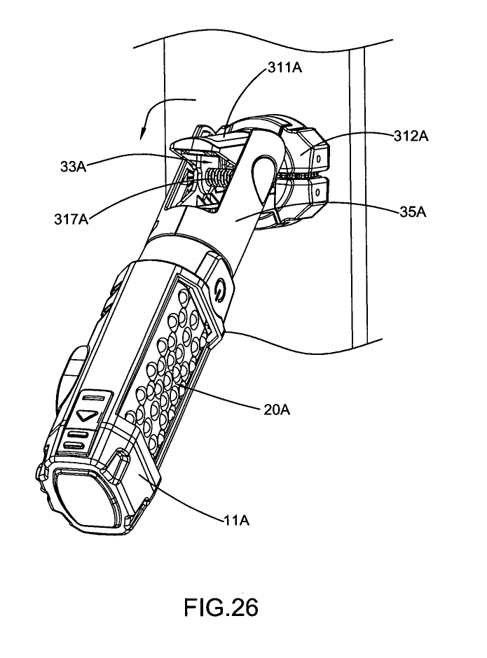

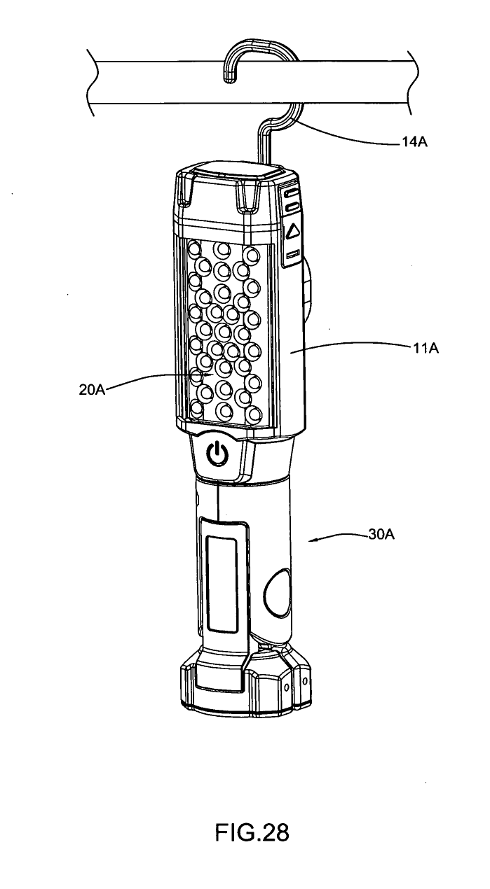

Referring to FIGS. 12-28 of the drawings, a portable lighting device according to a second preferred embodiment of the present invention is illustrated. According to this preferred embodiment, the portable lighting device comprises a light housing 10A, a light source 20A, and a direction adjusting arrangement 30A. Similarly, the light source 20A is supported by the light housing 10A and the light beams of the light source 20A project out from the light housing 10A for providing illumination. The direction adjusting arrangement 30A is movably coupled with the light housing 10A in such a manner that a direction of the light beams of the light source 20A can be adjusted by means of a relative movement between the light housing 10 and the direction adjusting arrangement 30A.

More specifically, the light housing 10A comprises a housing body 11A which comprises a first housing 111A which can be embodied as an inner housing and a second housing 112A which can be embodied as an outer housing which is assembled at an outer side of the inner housing. Accordingly, the housing body 11A forms a receiving cavity 113A having a light opening 115A, the light source 20A is received in the receiving cavity 113A and the light beams of the light source 20A project out of the housing body 11A through the light opening 115A.

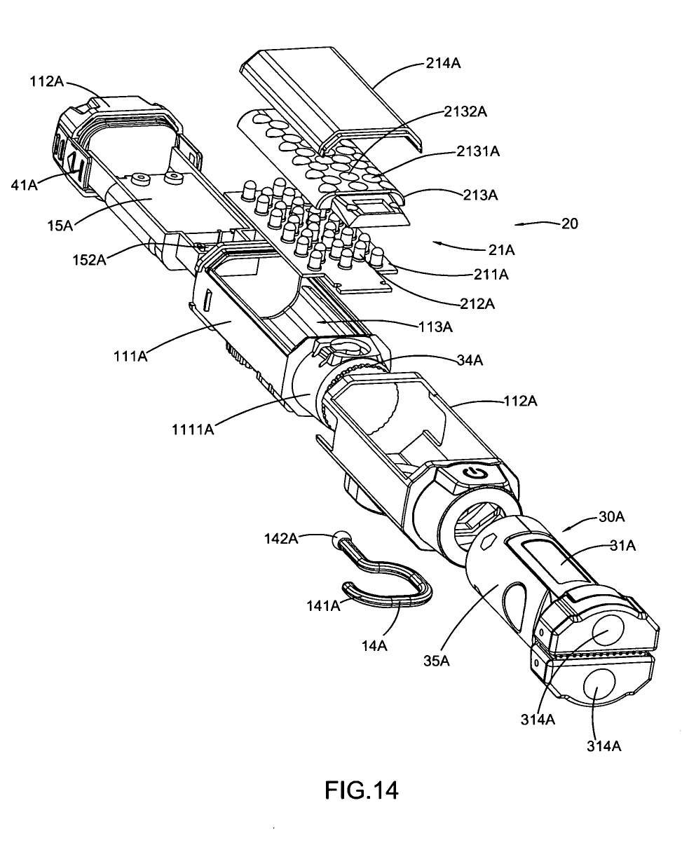

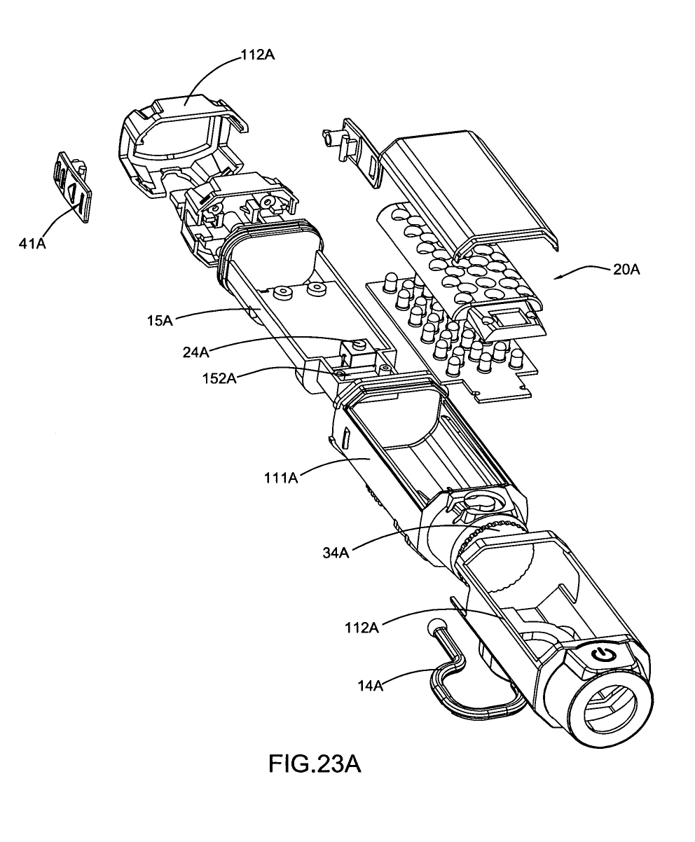

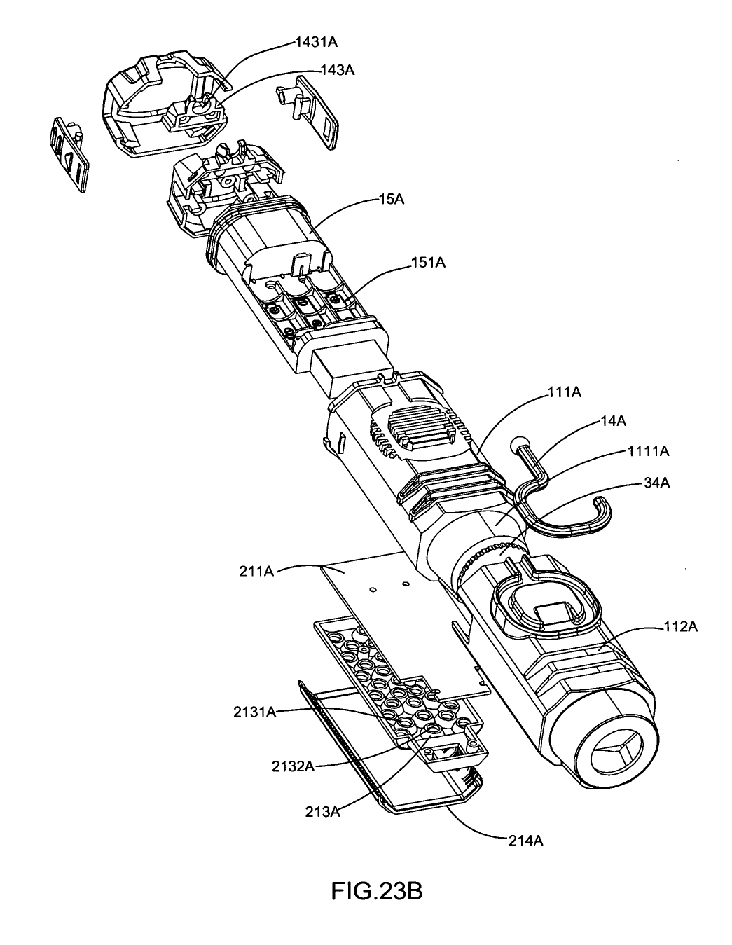

Referring to FIGS. 14 and 23A-23B of the drawings, the light housing 10A may further comprises a power source casing 15A mounted to the housing body 11A in the receiving cavity 113A. Accordingly, the power source casing 15A of this preferred embodiment forms a battery chamber 151A for receiving a power source 40A which can be embodied as a rechargeable battery and a control chamber 152A for receiving a control circuit 24A which can be actuated via a control button 23A by the user. The rechargeable battery is further provided with recharging interface 41A at the housing body 11A for recharging the battery. For example, the recharging interface 41A can be embodied as a USB interface. In addition, the battery chamber 151A and the control chamber 152A may be formed at two opposite sides of the power source casing 15. According to this preferred embodiment, the control chamber 152A is fitted into an end portion 1111A of the inner casing 111A which can be embodied as an elongated tube to align with the control button 23A. The engagement between the control button 23A and the control circuit 24 for activating the light source 20A can be accomplished in many suitable manners.

Similarly, the light source 20A of this preferred embodiment comprises at least one lighting unit 21A which comprises a circuit board 211A which is electrically connected to the power source 40A, and one or more lighting members 212A each of which can be embodied as an LED illumination member mounted on the circuit board 211A. As an option, the lighting unit 21A further comprises one or more light reflecting members 213A, and a light distributing lid 214A. Accordingly, areas of the light distributing lid 214A corresponding to the lighting members 212A or the entire light distributing lid 214A are made of transparent material. The housing body 11A of the light housing 10A forms the light opening 115A for mounting the light distributing lid 214A in position. Therefore, the lighting members 212A are powered by the power source 40A to produce light beams, and then the light beams project out through the light distributing lid 214A to provide a lighting pattern.

According to this preferred embodiment, the lighting unit 21A comprises an integral light reflecting member 213A which has a plurality of light reflecting channel 2131A penetrating a thickness of the light reflecting member 213A. Each of the light reflecting channel 2131A is formed with a light reflecting wall 2132A which can be cone-shaped. Therefore, each of the lighting members 212A can be received in the corresponding light reflecting channel 2131A, and the light beams reaching to the light reflecting wall 2132A are reflected, so that the light beams are collected and gathered to project out through the light distributing lid 214A so as to enhance the light efficiency. Alternatively, the light reflecting member 213A may only have a single light reflecting channel 2131A for receiving the plurality of lighting members 212A, and a single light reflecting wall 2132A for reflecting and collecting the light beams of the plurality of lighting members 212A.

As shown in the drawings of this preferred embodiment, the circuit board 211A of the lighting unit 21A can be supported by the power source casing 15A. In other words, unlike the above first embodiment in which the power source 40 and the light source 20 are arranged along the length of the housing body 11, the power source 40A and the light source 20A of this preferred embodiment are arranged along a width of the housing body 11A. In addition, the light distributing lid 214A is mounted with the second housing 112A which is an outer casing.

According to this preferred embodiment, the combination of the light housing 10A and the light source 20A can form a typical lighting device without direction adjusting function, just like a conventional flashlight. However, this preferred embodiment of the present invention provides add-on direction adjusting arrangement 30A for adjusting the light projecting direction of the light source 20A. In other words, the conventional lighting devices can be modified to provide the portable lighting device with direction adjusting function of the present invention by introducing the direction adjusting arrangement 30A of this preferred embodiment without altering the original design of the conventional lighting device.

More specifically, the direction adjusting arrangement 30A comprises a rotating element 34A which is mounted to the housing body 11A, for example, the rotating element 34A is mounted to the end portion 1111A of the inner casing 111A at an outer side of the housing body 11A. Referring to FIGS. 14-15 and 21-22 of the drawings, the direction adjusting arrangement 30A further comprises a rotating casing 35A which is rotatably coupled to the rotating element 34A in such a manner that the housing body 11A is capable of rotating with respect to an central axis X thereof, as shown in FIG. 25 of the drawings. In other words, the housing body 11A of this preferred embodiment can rotate along the circumferential direction thereof so as to adjust the position of the light opening 214A, and thus the direction of the light beams of the light source 20A can be adjusted.

The rotatable engaging manner between the rotating element 34A and the rotating casing 35A can be achieved by any suitable manners. According to this preferred embodiment, the rotating element 34A is construed to be a rotating gear comprising a main rotating body 341A, a plurality of engaging teeth 342A and having a plurality of engaging grooves 343A formed between two adjacent engaging teeth 342A along an outer circumferential surface of the main rotating body 341A. The rotating casing 35A comprises an engaging casing portion 351A and a support casing portion 352A integrally extended from the engaging casing portion 351A. The engaging casing portion 351A has an engaging cavity 3511A, and comprises a plurality of engaging protrusion 3512A formed along an inner circumferential surface thereof. The rotating element 34A is suitable for fitting into the engaging cavity 3511A in such a manner that the plurality of engaging protrusion 3512A is respectively coupled with the plurality of engaging grooves 343A. Thus, by rotating the rotating element 34A with respect to the rotating casing 35A, the housing body 11A mounted to the rotating element 34A is driven to rotate so that the light source 20A can be guided to face towards various directions. Alternatively, the structure of the rotating element 34A may be mounted with the support casing portion 352A while the structure of the engaging casing portion 351A may be integrated with the housing body 11A.

It is worth mentioning that the portable lighting device of this preferred embodiment also can be constructed to be cylindrical shaped. Accordingly, an outer diameter of the housing body 11A can be the same as an outer diameter of the direction adjusting arrangement 30A, so that the two parts are assembled together to form an integral cylindrical structure, so that the aesthetic appearance of the portable lighting device of this preferred embodiment of the present invention is enhanced.

Referring to FIGS. 14 to 20 of the drawings, the direction adjusting arrangement 30A further comprises a support unit 31A, a rotation unit 32A. As shown in the drawings, the support unit 31A is rotatably coupled to the corresponding rotation unit 32A. Accordingly, the support casing portion 352A of the rotating casing 35 of the direction adjusting arrangement 30A further defines a rotation cavity 33A, and the support unit 31A is capable of being rotated in and out of the rotation cavity 33A, so that the extending direction of the housing body 11 which is coupled with the rotating casing 35 via the rotating element 34 can be adjusted.

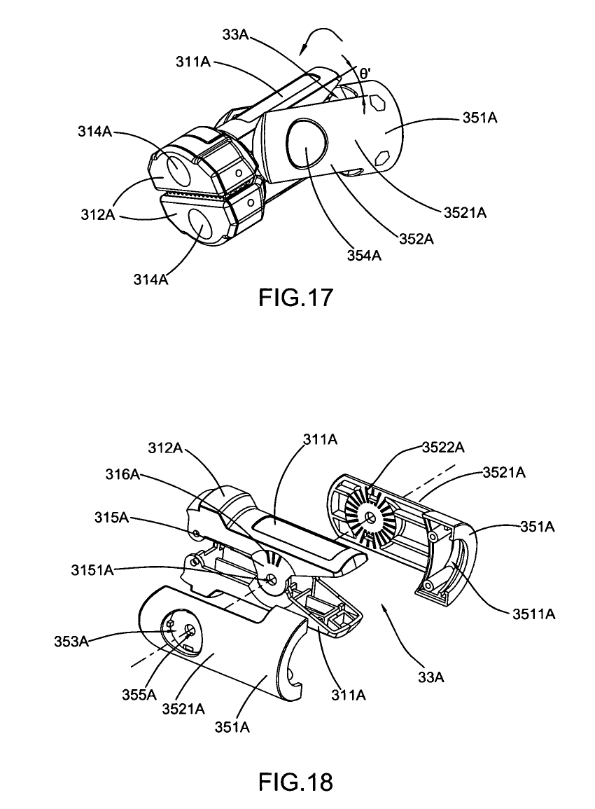

More specifically, as an example, the support casing portion 352A of the rotating caving 35A comprises two casing legs 3521A which are respectively extended from the engaging casing portion 351A. The two casing legs 3521A are parallelly and spacedly arranged with each other to define the rotation cavity 33A therebetween. Both of the rotating casing 35A and the housing body 11A are arranged in the same direction which is along a length of the portable lighting device. Therefore, when the support unit 31A is rotated around the rotation unit 32A, an angle θ′ is actually defined between the support unit 31A and the rotating casing 35A of the direction adjusting arrangement 30A, as shown in FIG. 17 of the drawings.

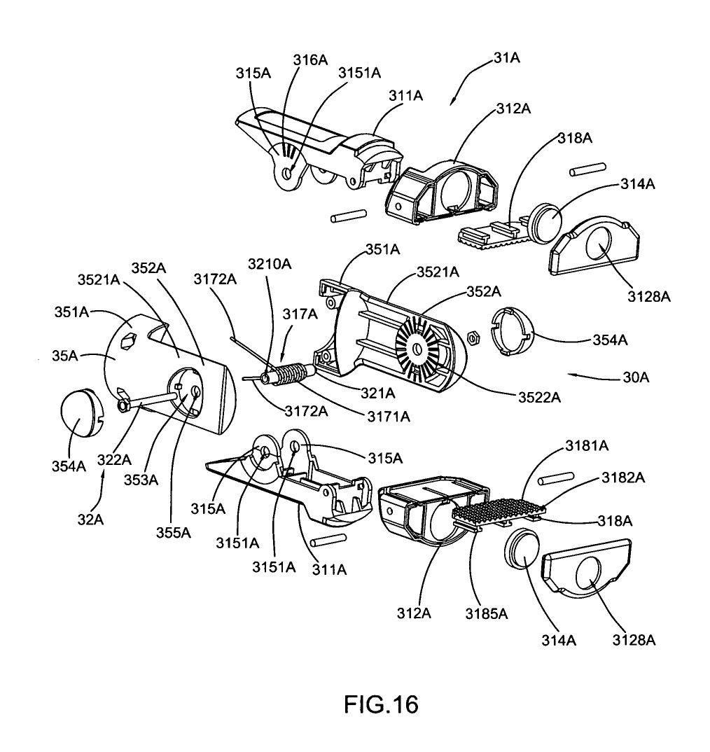

Referring to FIG. 16 of the drawings, according to this preferred embodiment, the support unit 31A comprises two support legs 311A, two support bases 312A mounted to the two support legs 311A respectively, and two pivot elements 315A integrally and parallelly extended from a middle portion of each of two support legs 311A towards the rotation cavity 33A. Accordingly, the two support legs 311A of the support unit 31A can be respectively embodied as an upper support leg and lower support leg. Each of the pivot elements 315A forms a penetrating hole 3151A penetrating a thickness thereof. The two pivot elements 315A extended from the upper support leg are respectively aligned with the two pivot elements 315A extended from the lower support leg in such a manner that the four penetrating holes 3151A are arranged in a same line. The two support legs 311A are fitted with the rotating casing 35A to define the rotation cavity 33A which receives the rotation unit 32A.

The rotation unit 32A comprises a rotating member which is embodied as a rotating tube 321A having an inner channel 3210A, and a retaining member which is embodied as a retaining shaft 322A. More specifically, the rotating tube 321A is mounted between the pivot elements 315A to align the inner channel 3210A with the four penetrating holes 3151A, so that the retaining shaft 322A is capable of penetrating through the four penetrating holes 3151A and the inner channel 3210A. Accordingly, an outer diameter of the retaining shaft 322A is matched with an inner diameter of the inner channel 3210A. The support unit 31A is capable of rotating with respect to the retaining shaft 322A so as to adjust the extending direction of the rotating casing 35A, so that the extending direction of the housing body 11A which is mounted with the rotating casing 35A is also adjusted.

The rotating casing 35A further defines two receiving grooves 353A at an outer side of each of the two support casing legs 3521A, and two sealing caps 354A are respectively fitted into the two receiving grooves 353A to mount the retaining shaft 322A in position, and two opening holes 355A communicating the receiving grooves 353A to the rotation cavity 33A. Accordingly, the two opposite ends of the retaining shaft 322A extend into the two receiving grooves 353A through the two opening holes 355A and bias the inner surfaces of the two sealing caps 354A respectively.

Referring to FIGS. 16 and 18 of the drawings, at least one pivot element 315A is integrally formed with one or more affixing protrusions 316A at an outer surface thereof, e.g. two pivot elements 315A which are respectively extended from the upper support leg 311A are formed with three affixing protrusions 315A. At least one support casing legs 3521A has a plurality of affixing grooves 3522A radially and spacedly formed with respect to the opening hole 355A. Accordingly, when the support unit 31A is stopped rotating, the affixing protrusions 315A are retained in the corresponding affixing grooves 3522A so as to block the further rotation of the support unit 31A. Accordingly, the number of the affixing grooves 3522 actually determines the range of the angle between the support legs 311A of the support unit 31A and the rotating casing 35A.

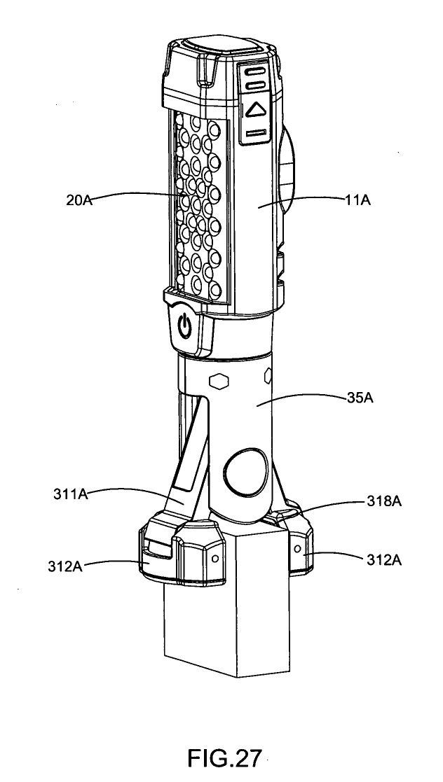

Furthermore, the support unit 31A further comprising a spring 317A including a spring body 3171A which is wound around the retaining tube 322A and two biasing legs 3172A extended from two opposite ends of the spring body 3171A respectively. The two biasing legs 3172A are respectively biasing the inner surface of the two support legs 311A to retain the two support legs 311A in position. The two support bases 312A of this preferred embodiment are respectively mounted to the two support legs 311A to form an entire cylindrical support base. According to this preferred embodiment, when pressing the two support legs 311A at distal end portions thereof adjacent to the housing body 11A, the two biasing legs 3172A are pressed to decrease the inclined angle between the two biasing legs 3172A, and thus the two support bases 312A at the proximate end portion thereof which are away from the housing body 11A will be departed from each other, so that an environment object can be clasped between the two support bases 312A, as shown in FIGS. 20 and 27 of the drawings.

The support unit 31A may further comprises two clasping board 318A, e.g. an upper clasping board and a lower clasping board, including a plurality of clasping teeth 3181A and having a plurality of clasping grooves 3182A. Accordingly, the two clasping boards 318A are respectively mounted in a seat groove 3183 formed in an inner side of each support base 312, and the plurality of clasping teeth 3181A and clasping grooves 3182A of one clasping board 318A are adapted for engaging with the plurality of clasping grooves 3182A and clasping teeth 3181A of the other clasping board 318A. Such a configuration of the two clasping board 318A can enhance the frictional contact between the environment object with the clasping board 318A so as to prevent the environment object to slip off. Each of the support base 312A is provided with at least one, such as three, locking grooves 3184 communicating with the seat groove 3183, and each of clasping board 318A further comprises at least one, such as three, locking legs 3185 which are fitted into the corresponding locking grooves 3184, so that the mechanical structure enables the assembly of each clasping board 318A with the corresponding support base 312A, and thus there is no need for glues or other bonding agent.

It is thus can be seen that another detachably mounting manner is introduced into the portable lighting device of this preferred embodiment. It is worth mentioning that the clasping structure of this preferred embodiment may be used for wearing the portable lighting device onto the user, so that the portable lighting device can be a wearable lighting device. For instance, the portable lighting device may be worn on a helmet or hat by simply clasping the edge of the helmet or the hat by the two clasping boards 318A, so that the portable lighting device can be arranged for providing illumination for the user, and there is no need for the user to use his or her hands to hold the portable lighting device.

Similarly, the portable lighting device of this preferred embodiment comprises one or more magnetic mounting member 314A provided in two mounting grooves 3128 in the support bases 312A. Accordingly, each of the magnetic mounting members 314A has magnetic attracting ability, and thus the magnetic mounting members 314A enable the direction adjusting arrangement 30A being mounted on a magnetic metal surface. The portable lighting device may further comprises a hook 14A which is rotatably mounted in a hook groove 118A of the housing body 11A. Accordingly, the hook 14A comprises a hook body 141A, a pivot ball 142A integrally extended from the hook body 141A, and a hook seat 143A defining a pivot groove 1431A. The hook seat 143A is supported in the housing body 11A, and the pivot ball 142A is rotatably mounted in the pivot groove 1431A of the hook seat 143A, so that the hook body 141A is capable of being rotated with respect to the pivot ball 142A.

It is thus can be seen that the present invention provides a method of manufacturing a portable lighting device according to this second preferred embodiment, the method comprises the following steps.

Prepare the light source 20A for providing illumination. According to this preferred embodiment, the light source 20A comprises one or more lighting units 21A. As an example, one lighting unit 21A may be formed for providing illumination at a lateral side of the housing body 11A. In some other examples, two or more lighting units 21A may be introduced for providing illumination at lateral sides and front or rear end sides of the housing body 11A. According to this preferred embodiment, the step of preparing the lighting unit 21A further comprises the step of mounting one or more lighting members 212A on the circuit board 211A, embedding the lighting members 212A into the light reflecting channels 2131A of the light reflecting member 213A in such a manner that the light reflecting member 213A is supported by the circuit board 211A and the light beams reaching to the lighting reflecting wall 2132A around the light reflecting channels 2131A can be reflected so as to condensing the first light beams.

Support the light source 20A in the housing body 11A of the light housing 10A. More specifically, the light source 20A is received in the receiving cavity 113A formed by the housing body 11A which is assembled by assembling the inner first casing 111A in the outer second casing 112A. In addition, in this step, the rotating element 34A is mounted to the housing body 11A.

Assemble the direction adjusting arrangement 30A. More specifically, the step comprises the steps of inserting the retaining shaft 322A into the inner channel 3210A of the rotating tube 321A, mounting the spring 317A around the rotating tube 321A, mounting the rotating tube 321A between the pivot elements 315A in such a manner that the retaining shaft 322A passes through the penetrating holes 3151A of the pivot elements 315A, inserting the retaining shaft 322A into the receiving grooves 353A through the opening holes 355A of the casing legs 3521A of the rotating casing 35A, mounting the sealing caps into the receiving grooves 353A to retain the retaining shaft 322A in position, and mounting the support legs 311A mounted with the support bases 312A respectively.

And finally, mount the direction adjusting arrangement 30A to the housing body 11A of the light housing 10A. Accordingly, in this step, the rotating casing 35A is mounted to the rotating element 34A which can be embodied as a rotating gear in a rotatable moving manner.

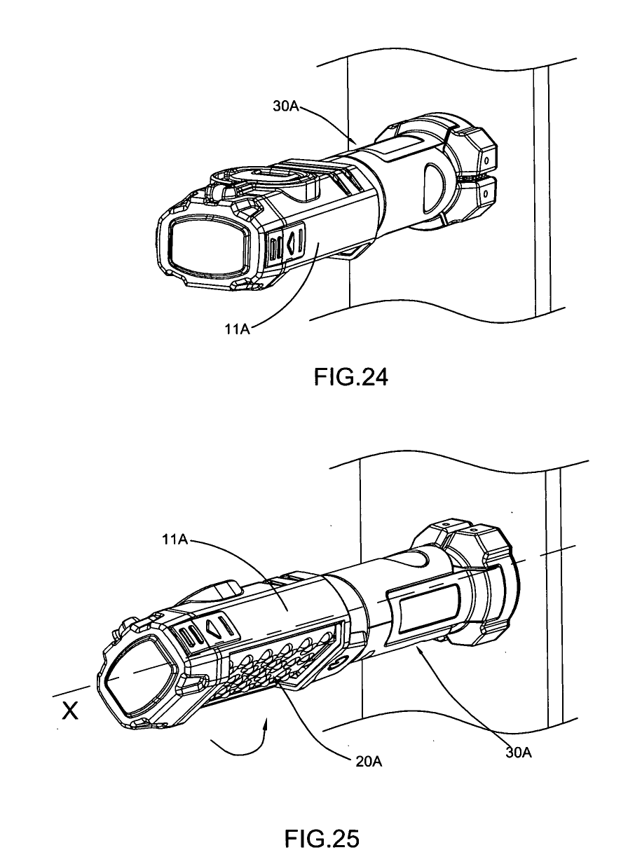

Referring to FIGS. 24-28 of the drawings, when in use, the portable lighting device of the present invention can be mounted to the environment for providing illumination. Accordingly, by rotating the housing body 11A of the light housing 10A with respect to its central axis X, and by rotating the support legs 311A of the direction adjusting arrangement 30A, the light beams of the lighting unit 21A can be directed to desired locations. Accordingly, in this preferred embodiment, two types rotating movement are introduced to adjust the projecting direction of the lighting unit 21A of the light source 20A. One type of the rotating movement is achieved by the engagement between the rotating element 34A and the rotating casing 35A of the direction adjusting arrangement 30A, another type of the rotating movement is achieved by the configuration of the support unit 31A and the rotation unit 32A.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A portable lighting device, comprising:
a light housing comprising a housing body defining a receiving cavity;
a light source which is supported in said receiving cavity of said housing body; and
a direction adjusting arrangement which is rotatably mounted with said housing body in such a manner that a projecting direction of said light source is capable of being adjusted by means of a relative movement between said housing body and said direction adjusting arrangement.

2. The portable lighting device, as recited in claim 1, wherein said direction adjusting arrangement comprises at least one rotation unit mounted to said housing body, and at least one support unit which is rotatably coupled with said rotation unit at an outer side of said housing body, wherein said support unit defines a rotation cavity, and when said support unit is rotated to move with respect to said rotation unit, at least a portion of said housing body is capable of being rotated in and out of said rotation cavity so as to adjust an angle between said support unit and said housing body.

3. The portable lighting device, as recited in claim 2, wherein said direction adjusting arrangement comprises two said rotation units mounted in said receiving cavity of said housing body along a width of said housing body, and two said support units rotatably coupled with said rotation units respectively along a length of said housing body, wherein said rotation cavity is formed by said two support units.

4. The portable lighting device, as recited in claim 3, wherein each of said support units comprises a pivot member which is rotatably coupled with said rotation unit, and a support leg extended from said rotation unit, wherein two said support legs are spacedly arranged with each other to define said rotation cavity therebetween.

5. The portable lighting device, as recited in claim 4, wherein each of said support units further comprises a support base connected to said support leg in such a manner that said support leg is extended between said pivot member and said support base, wherein said two support units are configured to form a U-shaped frame which allows said portion of said housing body to rotate in and out of said rotation cavity.

6. The portable lighting device, as recited in claim 4, wherein each of said rotation units comprises a retaining member defining a rotation channel, and a rotating member which is rotatably mounted in said rotation channel of said retaining member, wherein said pivot member is operatively coupled with said rotating member in such a manner that when said pivot member is rotated, said rotating member is driven to rotate in said rotation channel of said retaining member.

7. The portable lighting device, as recited in claim 6, wherein each of said pivot members comprises a cap body, and a central shaft extended from an inner surface of said cap body within said cap body, wherein said rotating member comprises a rotating portion and a connecting portion connected to said rotating portion, wherein said connecting portion defines a connecting channel, and said central shaft of said pivot member is received in said connecting channel of said connecting portion of said rotating member for simultaneously rotating with said rotating portion.

8. The portable lighting device, as recited in claim 7, wherein each of said pivot members further comprises at least one driving panel transversely extended from said central shaft, wherein said connecting portion of said rotating member has at least one slot, and said driving panel is fitted into said slot to drive said connecting portion of said rotating member to rotate in response to a rotation of said pivot member.

9. The portable lighting device, as recited in claim 8, wherein each of said rotating portion of said rotating member has an outer circumferential surface, wherein each of said retaining members has an inner circumferential surface, wherein each of said rotating members further comprises at least one retaining protrusion protruded from said outer circumferential surface of said rotating portion of said rotating member, wherein each of said retaining members further has a plurality of retaining grooves formed along said inner circumferential surface around said rotation channel of said retaining member, wherein when said rotating member stops rotating, said retaining protrusion is retained in one of said retaining grooves to block a further movement of said rotating member.

10. The portable lighting device, as recited in claim 9, wherein each of said rotating member further comprises at least one retaining ribs radially extended from said rotating portion at an outer side of said rotation channel thereof for retaining said retaining member in position.

11. The portable lighting device, as recited in claim 10, wherein each of said rotating members further comprises at least one retaining arm transversely extended from said connecting portion thereof, and are retained between said cap body and said central shaft of said pivot member so as to enhance a frictional contact between said pivot member and said rotating member.

12. The portable lighting device, as recited in claim 6, wherein said light housing further comprises a seat portion defining a circular groove at each of two lateral sides of said housing body, and a retention portion defining a retention groove, wherein said seat portion and said retention portion are respectively connected to said housing body, and said circular groove and said retention groove are respectively provided for mounting said pivot member and said retaining member in position.

13. The portable lighting device, as recited in claim 1, wherein said direction adjusting arrangement comprises a rotating element, and a rotating casing, wherein one of said rotating element and said rotating casing is mounted to said housing body, wherein said rotating casing is rotatably mounted with said rotating element in such a manner that said housing body is capable of being rotated along a circumferential direction by means of a relative movement between said rotating element and said rotating casing.

14. The portable lighting device, as recited in claim 13, wherein said rotating element is embodied as a rotating gear comprising a main rotating body defining an outer circumferential surface, a plurality of engaging teeth and having a plurality of engaging grooves formed between two adjacent said engaging teeth along said outer circumferential surface of said main rotating body, wherein said rotating casing comprises an engaging casing portion having an inner circumferential surface defining an engaging cavity, and comprises a plurality of engaging protrusion formed along said inner circumferential surface thereof, wherein said rotating element is fitted into said engaging cavity in such a manner that said plurality of engaging protrusion is respectively received in said plurality of engaging grooves.

15. The portable lighting device, as recited in claim 14, wherein said rotating element is connected to said housing body, wherein said rotating casing further comprises a support casing portion extended from the engaging casing portion to define a rotation cavity, wherein said direction adjusting arrangement further comprises a rotation unit and a support unit rotatably coupled with said rotation unit, wherein said support unit is capable of being rotated with respect to said rotation unit in said rotation cavity.

16. The portable lighting device, as recited in claim 15, wherein said support unit comprises at least one support leg, and at least one pivot element transversely extended from said support leg, wherein said pivot element has a penetrating hole penetrating a thickness thereof, wherein said rotation unit comprises a retaining shaft penetrating said penetrating hole of said pivot element, wherein said pivot element is capable of rotating with respect to said retaining shaft.

17. The portable lighting device, as recited in claim 16, wherein said support unit comprises two said support legs, wherein said pivot elements are aligned to arrange said penetrating holes in a same line, wherein said support unit further comprises two support bases connected to said support legs respectively.

18. The portable lighting device, as recited in claim 17, wherein said rotating unit further comprises a rotating tube having an inner channel, wherein said rotating tube is mounted between said pivot elements of said support unit in such a manner that said retaining shaft penetrating said penetrating holes of said pivot elements and said inner channel of said rotating tube.

19. The portable lighting device, as recited in claim 18, wherein said support unit further comprising a spring comprising a spring body wound around said rotating tube, and two biasing legs biasing said two support legs respectively, wherein when said two support legs are pressed inwardly, said two support bases are departed from each other for clasping on an environment object.

20. The portable lighting device, as recited in claim 19, wherein each of said support bases is mounted with a clasping board comprising a plurality of clasping teeth for enhancing a frictional contact between said clasping board and the environment object.

21. The portable lighting device, as recited in claim 19, wherein said support casing portion of said rotating casing comprises two casing legs extended from the engaging caving portion respectively, wherein at least one of said casing legs has a plurality of affixing grooves radially formed at an inner side thereof, wherein said support unit further comprises at least one affixing protrusion outwardly extended from said pivot member for matching with said affixing grooves, wherein when said support unit stops rotating, said affixing protrusion is retained in one of said affixing grooves to block a further movement of said support unit.

22. The portable lighting device, as recited in claim 19, wherein each of said casing legs has a receiving groove at an outer side thereof, and an opening hole which communicates said receiving groove with said rotation cavity, wherein said retaining shaft extends into said receiving groove through said opening hole, wherein a sealing caps is fitted into said receiving grooves to mount said retaining shaft in position.

23. The portable lighting device, as recited in claim 2, wherein said light source comprises at least one lighting unit which comprises a circuit body for receiving a power supply, at least one lighting member electrically connected to said circuit body, and at least one light reflecting member having at least one light reflecting wall and at least one light reflecting channel, wherein said lighting member is mounted into said light reflecting channel in such a manner that light beams of said lighting member which reach to said light reflecting wall are reflected by said light reflecting wall for collecting said light beams.

24. The portable lighting device, as recited in claim 13, wherein said light source comprises at least one lighting unit which comprises a circuit body for receiving a power supply, at least one lighting member electrically connected to said circuit body, and at least one light reflecting member having at least one light reflecting wall and at least one light reflecting channel, wherein said lighting member is mounted into said light reflecting channel in such a manner that light beams of said lighting member which reach to said light reflecting wall are reflected by said light reflecting wall for collecting said light beams.

25. The portable lighting device, as recited in claim 23, wherein said light source comprises two or more said lighting units, wherein at least one of said lighting units is longitudinally arranged in said receiving cavity of said housing body while at least one of said lighting units is transversely arranged in said receiving cavity of said housing body, wherein each of said lighting unit further comprises a light distributing lid which is mounted to said housing body for allowing said light beams of said lighting member which is embodied as an LED lighting member to pass therethrough.

26. The portable lighting device, as recited in claim 24, wherein said light source comprises two or more said lighting units, wherein at least one of said lighting units is longitudinally arranged in said receiving cavity of said housing body while at least one of said lighting units is transversely arranged in said receiving cavity of said housing body, wherein each of said lighting unit further comprises a light distributing lid which is mounted to said housing body for allowing said light beams of said lighting member which is embodied as an LED lighting member to pass therethrough.

27. The portable lighting device, as recited in claim 5, wherein said direction adjusting arrangement further comprises one or more magnetic mounting members which are mounted to said support base for magnetically and detachably mounting to a magnetic environment surface.

28. The portable lighting device, as recited in claim 17, wherein said direction adjusting arrangement further comprises one or more magnetic mounting members which are mounted to said support base for magnetically and detachably mounting to a magnetic environment surface.

29. The portable lighting device, as recited in claim 11, wherein said light housing further comprises a hook rotatably coupled to said housing body.

30. The portable lighting device, as recited in claim 19, wherein said light housing further comprises a hook rotatably coupled to said housing body.
